(19) United States
(12) Patent Application Publication
(10) Pub. No.: US 2010/0252406 A1
(43) Pub. Date: Oct. 7, 2010

(54) KEYSWITCH AND KEYBOARD

(76) Inventor: Yi-Chen Wang, Yongkang City (TW)

Correspondence Address: NORTH AMERICA INTELLECTUAL PROPERTY CORPORATION, P.O. BOX 506, MERRIFIELD, VA, 22116, US

(21) Appl. No.: 12/751,539

(22) Filed: Mar. 31, 2010

(30) Foreign Application Priority Data
Apr. 2, 2009 (TW) 098205288

(51) Int. Cl. H01H 13/7065

(52) U.S. Cl. 200/344

(57) ABSTRACT

A keyswitch and a keyboard are provided. The keyboard includes the keyswitch, and the keyswitch includes a base, an engaging structure, a balance beam, and a key cap. The engaging structure is disposed on the base and has a guiding surface. The balance beam has a bending portion which is adapted to be engaged in the engaging structure. The key cap has a pivotal structure for pivotally connecting with the balance beam. When the balance beam is forced toward the engaging structure to be assembled on the base, the bending portion is guided by the guiding surface to be engaged with the engaging structure.

### BACKGROUND OF THE INVENTION

1. Field of the Invention

The invention relates to a keyswitch, and more particularly, to a keyswitch structure having a balance beam capable of being assembled easily.

2. Description of the Prior Art

With the growth of information technology, the information equipment will be also become popular gradually. Taking the most-used computer for example, there are various brands and types of computers on the market, and the application range of the computer even extends to the places such as family, factory, company, office, and school. The use level of the computer reaches all levels and almost becomes everyday essential items in daily life. In the well-known computer, such as desktop computer and notebook, a keyboard is needed for the user to input a character or other input operations.

As to the keyboard used in current desktop computer, the keyboard has a key cap and a base, and a key column is disposed between the key cap and the base. When the user presses a keyswitch on the keyboard, the key column will support the key cap to move vertically relative to the base. In this way, when the key cap is pressed, the switch on the base can be triggered to transfer a reference signal to the processor to trigger the processor to output a suitable output signal. The shape of the conventional keyswitch (e.g., the functional keyswitch of A, F1, or ESC) of the keyboard is mostly square, and the structures and operation methods of these keyswitches are mentioned above.

In addition, there are also some special multiple keyswitches (e.g., SPACE, SHIFT, and ENTER) on the keyboard having longer length or special shape. These keyswitches may have special appearance based on the using frequency or keyboard configuration.

For example, when the user types characters, the keyswitch “SPACE” is usually used. In order to let the user press the keyswitch “SPACE” easily, the keyswitch “SPACE” on the keyboard is often designed to have a longer appearance, so that the user can use his/her thumb to press the keyswitch “SPACE”.

However, since the keyswitch “SPACE” is longer, the user may press the two sides of the keyswitch “SPACE” instead of the central position of the keyswitch “SPACE”. As a result, the keyswitch “SPACE” will become tilted and unstable, or fail to trigger the switch corresponding to the keyswitch “SPACE”, even the keyswitch “SPACE” will be damaged. Therefore, a balance beam is usually disposed on the current multiple switches to be pivoted on the bottom of the key cap and the base. The balance beam can prevent the multiple keyswitches from being tilted and unstable, and the pressing force of the user can be uniformly distributed to everywhere on the keyswitch. Even the user presses on a corner of the keyswitch, and the corner is far away from the triggering switch, the pressing force of the user can be uniformly distributed to the entire keyswitch, so that the keyswitch will become more sensitive and comfortable for the user.

However, conventionally, the balance beam must be completely assembled by manpower; the balance beam may fail to be assembled on the correct position due to the worker's carelessness. Moreover, the efficiency will become poor because the workers are overworked, and the manpower cost will become higher, and these drawbacks will be negative to the enterprise earnings.

Therefore, the invention provides a keyswitch and a keyboard, the assembling method of its balance beam is to use the guiding surface to guide the balance beam to be engaged with the engaging structure. In this way, the balance beam can be vertically or horizontally assembled instead of being assembled one after one by hands. When the balance beam is assembled vertically or horizontally, an entire row or face of balance beams can be assembled at the same time by the equipment. By doing so, not only the manpower cost will be saved and the human error will be prevented, but also the productivity can be enhanced to increase the enterprise earnings.

### SUMMARY OF THE INVENTION

The invention discloses a keyswitch including a base, an engaging structure, a balance beam, and a key cap. The engaging structure is disposed on the base and has a guiding surface. The balance beam has a bending portion adapted to be engaged in the engaging structure. The key cap has a pivotal structure for pivotally connecting with the balance beam. Wherein, when the balance beam is forced toward the engaging structure to be assembled on the base, the bending portion is guided by the guiding surface to be engaged with the engaging structure.

The invention discloses a keyboard including a base and a plurality of keyswitches. The plurality of keyswitches is disposed on the base, wherein each of plurality of keyswitches includes an engaging structure, a balance beam, and a key cap. The engaging structure is disposed on the base and has a guiding surface. The balance beam has a bending portion adapted to be engaged in the engaging structure. The key cap has a pivotal structure for pivotally connecting with the balance beam. Wherein, when the balance beam is forced toward the engaging structure to be assembled on the base, the bending portion is guided by the guiding surface to be engaged with the engaging structure.

Compared to the prior art, in the keyswitch and the keyboard of the invention, the assembling method of the balance beam is to use the guiding surface to guide the balance beam to be engaged with the engaging structure. In this way, the balance beam can be vertically or horizontally assembled instead of being assembled one after one by hands. When the balance beam is assembled vertically or horizontally, an entire row or face of balance beams can be assembled at the same time by the equipment. By doing so, not only the manpower cost will be saved and the human error will be prevented, but also the productivity can be enhanced to increase the enterprise earnings.

The objective of the present invention will no doubt become obvious to those of ordinary skill in the art after reading the following detailed description of the preferred embodiment, which is illustrated in the various figures and drawings.

### BRIEF DESCRIPTION OF THE APPENDED DRAWINGS

FIG. 1A shows an exploded diagram of a keyswitch of an embodiment in the invention.

FIG. 1B shows a scheme diagram of the engaging structure shown in FIG. 1A.

FIG. 1C shows a combination scheme diagram of the keyswitch shown in FIG. 1A.

FIG. 1D shows a scheme diagram of the balance beam and the engaging structure shown in FIG. 1A.

FIG. 1E shows a scheme diagram of another embodiment of the engaging structure shown in FIG. 1A.

FIG. 2A shows a scheme diagram of another embodiment of the engaging structure shown in FIG. 1A.

FIG. 2B shows a top view of the engaging structure and the balance beam shown in FIG. 2A.

FIG. 2C shows a top view of the engaging structure and the balance beam shown in FIG. 2A.

FIG. 3A shows a scheme diagram of another embodiment of the engaging structure shown in FIG. 1A.

FIG. 3B shows a side view of the engaging structure and the balance beam shown in FIG. 3A.

FIG. 3C shows a scheme diagram of the balance beam assembled on the engaging structure shown in FIG. 3B.

FIG. 3D shows a scheme diagram of the balance beam assembled on the engaging structure shown in FIG. 3C.

### DETAILED DESCRIPTION OF THE INVENTION

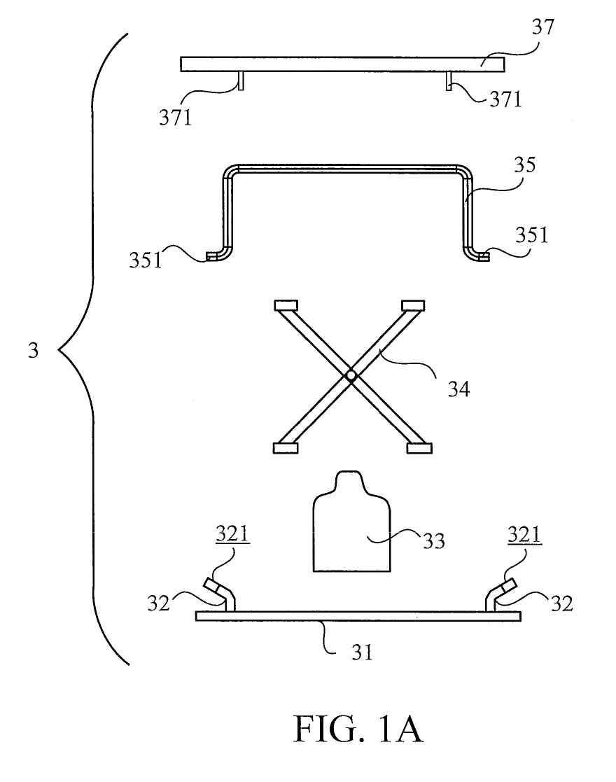

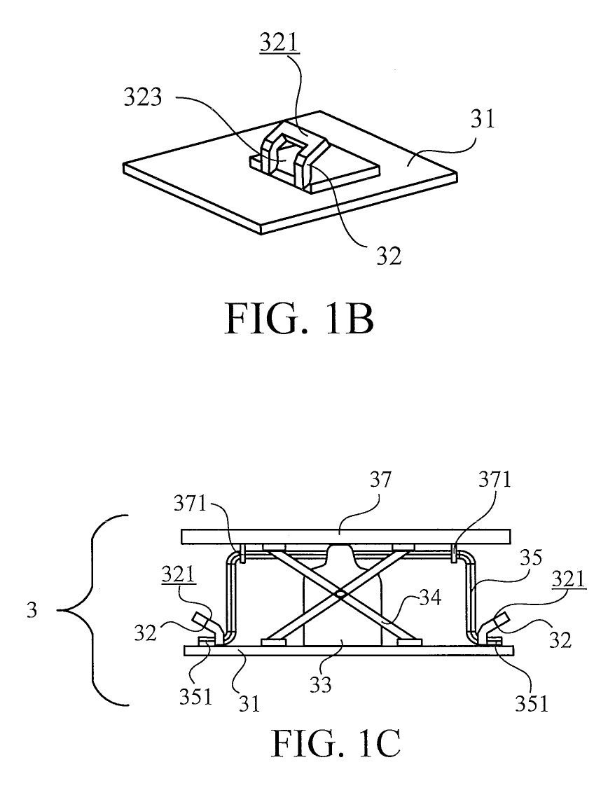

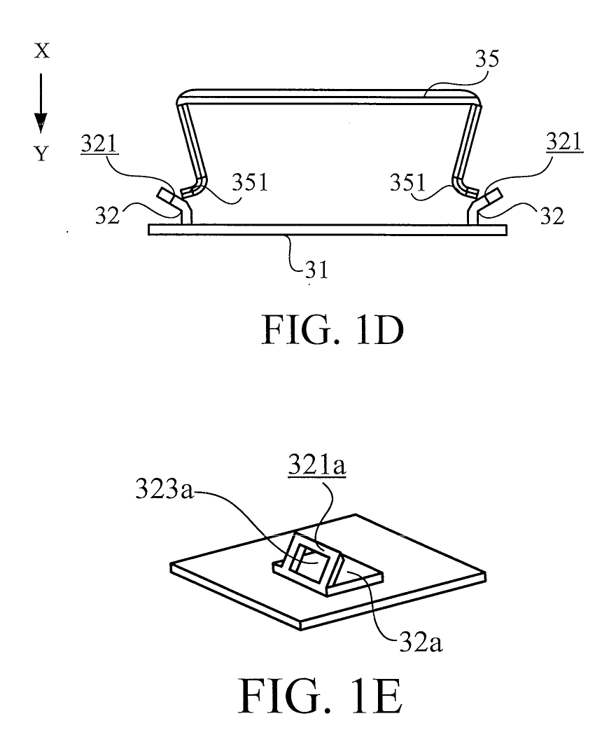

Please refer to FIG. 1A. FIG. 1A shows an exploded diagram of a keyswitch 3 of an embodiment in the invention. The keyswitch 3 of the invention includes a base 31, an engaging structure 32, an elastic object 33, a supporting component 34, a balance beam 35, and a key cap 37.

Please refer to FIG. 1A, FIG. 1B, and FIG. 1C. FIG. 1B shows a scheme diagram of the engaging structure 32 shown in FIG. 1A. FIG. 1C shows a combination scheme diagram of the keyswitch 3 shown in FIG. 1A. As shown in FIG. 1A, FIG. 1B, and FIG. 1C, the engaging structure 32 is disposed on the base 31, and the base 31 and the engaging structure 32 are one-batch formed, but not limited to this case. In addition, the engaging structure 32 has a guiding surface 321 and an engaging hole 323, wherein the guiding surface 321 can be a tilted surface or an arc surface having the guiding function, but not limited to this case.

The elastic object 33 can be disposed the base 31 and connected to the key cap 37 upward. The supporting component 34 is connected to the base 31 and the key cap 37, and the supporting component 34 is used to support the key cap 37 to move vertically relative to the base 31. The balance beam 35 has a bending portion 351 adapted to be engaged in the engaging structure 32. Particularly, the bending direction and angle of the bending portion 351 of the balance beam 35 are not specially limited, and they can be elastically changed by the designer based on practical needs or design limitations. In addition, the number of the bending portion 351 of the balance beam 35 is not limited. For example, the balance beam 35 of this embodiment has two bending portions 351, but not limited to this case. The key cap 37 has a pivotal structure 371 for pivotally connecting with the balance beam 35. Particularly, the final combination scheme diagram of the keyswitch 3 is shown in FIG. 1C. Wherein, the bending portion 351 of the balance beam 35 is engaged into the engaging hole 323 and is further limited in the engaging hole 323.

The connection relationships between the components of the keyswitch 3 of the invention are described in detail above. Therefore, the following will especially describe the practical actuation method between the balance beam 35 and the engaging structure 32 of the keyswitch 3 in the invention.

Please refer to FIG. 1D. FIG. 1D shows a scheme diagram of the balance beam 35 and the engaging structure 32 shown in FIG. 1A. As shown in FIG. 1D, when the bending portion 351 of the balance beam 35 is engaged into the engaging hole 323 of the engaging structure 32 from X direction to Y direction (it should be noticed that it is vertical direction from X direction to Y direction relative to the base 31), the balance beam 35 will be pressed to generate deformation. Please pay special attention that the balance beam 35 and the engaging structure 32 can be made of an elastic material or an elastic material. Therefore, when the bending portion 351 of the balance beam 35 vertically enters into the engaging structure 32, the bending portion 351 will be deformed inward and bended along the guiding surface 321.

In other words, when the balance beam 35 is assembled to the engaging structure 32, the balance beam 35 will slide into the engaging hole 323 along the direction of the guiding surface 321. At the same time of sliding, the balance beam 35 will also generate deformation due to the resistant force of the guiding surface 321 to further slide into the engaging hole 323 along the tilted surface of the guiding surface 321. After the bending portion 351 smoothly slides into the engaging hole 323, since the balance beam 35 is not pressed by the tilted surface of the guiding surface 321, therefore, the balance beam 35 can recover its original shape. After the balance beam 35 recovers its original shape, the bending portion 351 can be fully engaged into the engaging hole 323, and the engaging hole 323 will limit the bending portion 351 of the balance beam 35, so that it will not move randomly.

Please refer to FIG. 1E. FIG. 1E shows a scheme diagram of another embodiment of the engaging structure shown in FIG. 1A. As shown in FIG. 1E, the engaging structure 32a includes a guiding surface 321a and an engaging hole 323a. Additionally, since the assembling theorem of the engaging structure 32a is the same with that of the engaging structure 32 shown in FIG. 1A, it will not be mentioned again here. It should be noticed that the only difference between the engaging structure 32a and the engaging structure 32 is that the appearance of the engaging structure 32a is fully tilted, but the appearance of the engaging structure 32 is still vertical to the base 31.

Above all, when the balance beam 35 assembled to the engaging structure 32 shown in FIG. 1B or the engaging structure 32a shown in FIG. 1E, the balance beam 35 provides a downward pressing force from up to down relative to the vertical direction of the base 31. And, since the balance beam 35 has the deformation characteristic of being elastic and recoverable, the bending portion 351 of the balance beam 35 will be guided into the engaging hole 323 and the engaging hole 323a along the guiding surface 321 of the engaging structure 32 or the guiding surface 321 of the engaging structure 32a to further achieve the goal of fixing the balance beam 35.

Then, the following will describe how to use assemble the balance beam to the engaging structure by using the horizontal push relative to the base. In addition, since the keyswitches mentioned as follows are the same with those mentioned above, and only the types of the engaging structure and the assembling direction are different, therefore, the following will only describe the conditions between the balance beam and the engaging structure.

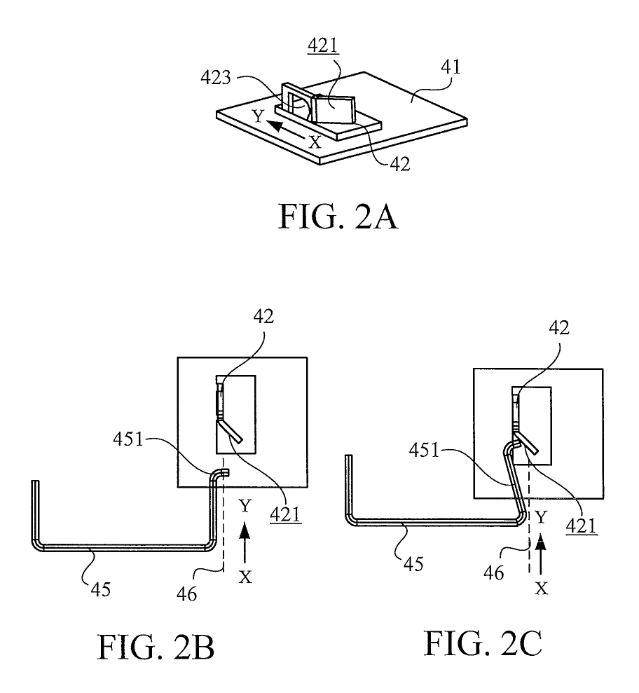

Please refer to FIG. 2A, FIG. 2B, and FIG. 2C. FIG. 2A shows a scheme diagram of another embodiment of the engaging structure 32 shown in FIG. 1A. FIG. 2B shows a top view of the engaging structure 42 and the balance beam 45 shown in FIG. 2A. FIG. 2C shows a top view of the engaging structure 42 and the balance beam 45 shown in FIG. 2A. As shown in FIG. 2A, FIG. 2B, and FIG. 2C, the engaging structure 42 is disposed on the base 41, and the base 41 and the engaging structure 42 can be one-batch formed, but not limited to this case. Additionally, the engaging structure 42 includes the guiding surface 421 and the engaging hole 423, wherein the guiding surface 421 can be a tilted surface, but not limited to this case.

When the balance beam 45 is assembled to the engaging structure 42, the bending portion 451 of the balance beam 45 is pushed to move along the direction from X toward Y (please noticed that the direction from X toward Y is parallel relative to the base 41). In addition, the balance beam 45 can be made of the plastic material or the elastic material. Therefore, when the bending portion 451 of the balance beam 45 is pressed by the guiding of the guiding surface 421, the bending portion 451 will generate deformation along the guiding surface 421. Particularly, the bending direction and angle of the bending portion 451 of the balance beam 45 are not specially limited, and fully defined by the designer. And, the number of the bending portion 451 of the balance beam 45 is not limited. Foe example, the balance beam 45 of the embodiment has one bending portion 451, and the bending portion 451 has corresponding engaging structure 42, but not limited to this case.

In further explanation, the bending portion 451 of the balance beam 45 has an initial position 46 under an initial state. When the bending portion 451 of the balance beam 45 moves from X toward Y direction, the bending portion 451 of the balance beam 45 will be pushed by the guiding surface 421 to be departed away from the initial position 46. And then, the bending portion 451 of the balance beam 45 can slide into the engaging hole 423 of the engaging structure 42 along the guiding surface 421. When the bending portion 451 of the balance beam 45 slides into the engaging hole 423, the bending portion 451 of the balance beam 45 will recover the initial position 46 and further engaged into the engaging hole 423.

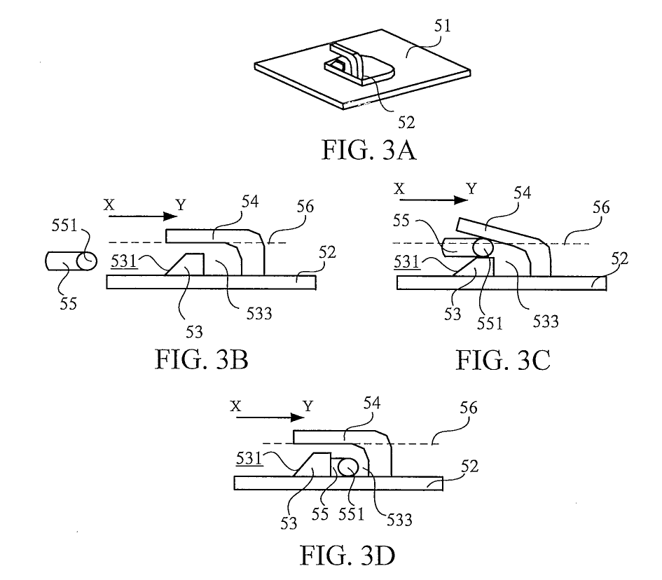

Please refer to FIG. 3A and FIG. 3B. FIG. 3A shows a scheme diagram of another embodiment of the engaging structure 32 shown in FIG. 1A. FIG. 3B shows a side view of the engaging structure 52 and the balance beam 55 shown in FIG. 3A. As shown in FIG. 3A and FIG. 3B, the engaging structure 52 is disposed on the base 51, and the engaging structure 52 includes a protruding portion 53, a guiding surface 531, and a position limiting component 54. Wherein, the guiding surface 531 is formed on the protruding portion 53; the position limiting component 54 and the protruding portion 53 form a position limiting portion 533.

In this embodiment, the position limiting component 54 locates on an initial position 56 without any influence caused by the external force. Particularly, the position limiting component 54 can be made of the plastic material or the elastic material, but not limited to this case.

Then, please refer to FIG. 3C and FIG. 3D. FIG. 3C shows a scheme diagram of the balance beam 55 assembled on the engaging structure 52 shown in FIG. 3B. FIG. 3D shows a scheme diagram of the balance beam 55 assembled on the engaging structure 52 shown in FIG. 3C. As shown in FIG. 3C and FIG. 3D, when the bending portion 551 of the balance beam 55 is assembled toward the engaging structure 52 from X to Y direction, the bending portion 551 of the balance beam 55 will be guided by the guiding surface 531 and push the position limiting component 54 at the same time. Since the position limiting component 54 has certain elastic force, therefore, it has certain deformation ability. Particularly, the bending direction and angle of the bending portion 551 of the balance beam 55 will not be limited, and can be fully defined by the designer. In addition, the number of the bending portion 551 of the balance beam 55 will not be limited. For example, the balance beam 55 of this embodiment has one bending portion 551, and the bending portion 551 has corresponding engaging structure 52, but not limited to this case.

Therefore, when the position limiting component 54 is pushed by the bending portion 551 of the balance beam 55, the position limiting component 54 will be pushed to be departed away from the initial position 56 upward. At this time, the bending portion 551 of the balance beam 55 will have moving space to be further engaged with the position limiting portion 533. After the bending portion 551 of the balance beam 55 is engaged with the position limiting portion 533, the position limiting component 54 will not be pushed by the he bending portion 551 of the balance beam 55, so that the position limiting component 54 can recover to its initial position 56. At last, the bending portion 551 of the balance beam 55 will be limited on the position limiting portion 533 by being blocked by the protruding portion 53 and the position limiting component 54.

In an embodiment, the invention also provides a keyboard (not shown in the figure). The keyboard includes a plurality of keyswitches, and at least one of the keyswitches has the above-mentioned structure. Since the characteristic of the keyboard and the effects it can achieve are the same as mentioned above, it will not be described again here.

Compared to the prior art, in the keyswitch and the keyboard of the invention, the assembling method of the balance beam is to use the guiding surface to guide the balance beam to be engaged with the engaging structure. In this way, the balance beam can be vertically or horizontally assembled instead of being assembled one after one by hands. When the balance beam is assembled vertically or horizontally, an entire row or face of balance beams can be assembled at the same time by the equipment. By doing so, not only the manpower cost will be saved and the human error will be prevented, but also the productivity can be enhanced to increase the enterprise earnings.

Although the present invention has been illustrated and described with reference to the preferred embodiment thereof, it should be understood that it is in no way limited to the details of such embodiment but is capable of numerous modifications within the scope of the appended claims.

What is claimed is:

1. A keyswitch, comprising:
a base;
an engaging structure, disposed on the base, the engaging structure having a guiding surface;
a balance beam having a bending portion adapted to be engaged in the engaging structure; and
a key cap having a pivotal structure for pivotally connecting with the balance beam;
wherein when the balance beam is forced toward the engaging structure to be assembled on the base, the bending portion is guided by the guiding surface to be engaged with the engaging structure.

2. The keyswitch of claim 1, wherein the engaging structure further comprises an engaging hole, when the balance beam is assembled toward the engaging structure, the bending portion is guided by the guiding surface to be engaged into the engaging hole.

3. The keyswitch of claim 1, wherein the base and the engaging structure are one-batch formed.

4. The keyswitch of claim 1, further comprising a supporting module, the supporting module comprising an elastic object and a supporting component, the supporting module being disposed between the base and the key cap and used for supporting the key cap to move vertically relative to the base.

5. The keyswitch of claim 1, wherein the engaging structure is made of a plastic material.

6. The keyswitch of claim 1, wherein the engaging structure is made of an elastic material.

7. The keyswitch of claim 1, wherein the engaging structure further comprises:
a protruding portion, the guiding surface is formed on the protruding portion; and
a position limiting component formed a position limiting portion with the protruding portion;
wherein when the balance beam is assembled toward the engaging structure, the bending portion is guided by the guiding surface to push the position limiting component away from an initial position to be engaged with the position limiting portion, and the bending portion is limited on the position limiting par by being blocked by the protruding portion and the position limiting component.

8. A keyboard, comprising:
a base; and
a plurality of keyswitches disposed on the base, each of the plurality of keyswitches comprising:
an engaging structure, disposed on the base, the engaging structure having a guiding surface;
a balance beam having a bending portion adapted to be engaged in the engaging structure; and
a key cap having a pivotal structure for pivotally connecting with the balance beam;
wherein when the balance beam is forced toward the engaging structure to be assembled on the base, the bending portion is guided by the guiding surface to be engaged with the engaging structure.

9. The keyboard of claim 8, wherein the engaging structure further comprises an engaging hole, when the balance beam is assembled toward the engaging structure, the bending portion is guided by the guiding surface to be engaged into the engaging hole.

10. The keyboard of claim 8, wherein the base and the engaging structure are one-batch formed.

11. The keyboard of claim 8, further comprising a supporting module, the supporting module comprising an elastic object and a supporting component, the supporting module being disposed between the base and the key cap and used for supporting the key cap to move vertically relative to the base.

12. The keyboard of claim 8, wherein the engaging structure is made of a plastic material.

13. The keyboard of claim 8, wherein the engaging structure is made of an elastic material.

14. The keyboard of claim 8, wherein the engaging structure further comprises:
a protruding portion, the guiding surface is formed on the protruding portion; and
a position limiting component formed a position limiting portion with the protruding portion;
wherein when the balance beam is assembled toward the engaging structure, the bending portion is guided by the guiding surface to push the position limiting component away from an initial position to be engaged with the position limiting portion, and the bending portion is limited on the position limiting par by being blocked by the protruding portion and the position limiting component.
